(19) United States
(12) Patent Application Publication
(10) Pub. No.: US 2019/0264024 A1
(43) Pub. Date: Aug. 29, 2019

(54) THERMOPLASTIC COMPOSITION WITH IMPROVED MECHANICAL PROPERTIES

(71) Applicant: PTT GLOBAL CHEMICAL PUBLIC COMPANY LIMITED, Bangkok (TH)

(72) Inventors: Jintana YUNYONGWATTANAKORN, Bangkok (TH); Apisit KOSITCHAIYONG, Bangkok (TH); Bunthita SUPPAIBULSUK, Bangkok (TH); Ruksapong KUNANURUKSAPONG, Bangkok (TH)

(73) Assignee: PTT GLOBAL CHEMICAL PUBLIC COMPANY LIMITED, Bangkok (TH)

(21) Appl. No.: 15/762,699

(22) PCT Filed: Sep. 23, 2016
(86) PCT No.: PCT/TH16/00078

§ 371 Date: Mar. 23, 2018

(30) Foreign Application Priority Data
Sep. 25, 2015 (TH) 1501005853

(51) Int. Cl. C08L 69/00

(52) U.S. Cl. CPC C08L 69/00; C08L 2201/08

(57) ABSTRACT

The present invention relates to a thermoplastic composition with improved mechanical properties in order to broaden applications of this composition, especially outdoor application. Said thermoplastic composition comprising 60 to 80 parts by weight of aromatic polycarbonate and 20 to 40 parts by weight of acrylonitrile-styrene-acrylate polymer, characterized in that said aromatic polycarbonate has linear structure and its molecular weight is in a range of 20,000 to 35,000 g/mol; and said acrylonitrile-styrene-acrylate polymer comprising 60 wt % or more of rubber grafted with styrene and acrylonitrile polymer and 40 wt % or less of styrene and acrylonitrile polymer.

### SUMMARY OF THE INVENTION

The present invention relates to a thermoplastic composition with improved mechanical properties, wherein said thermoplastic composition comprising 60 to 80 parts by weight of aromatic polycarbonate and 20 to 40 parts by weight of acrylonitrile-styrene-acrylate polymer, characterized in that said aromatic polycarbonate has linear structure and its molecular weight is in a range of 20,000 to 35,000 g/mol; and said acrylonitrile-styrene-acrylate polymer comprising 60 wt % or more of rubber grafted with styrene and acrylonitrile polymer and 40 wt % or less of styrene and acrylonitrile polymer.

### FIELD OF THE INVENTION

This invention is in the field of chemistry relating to the thermoplastic composition.

### BACKGROUND OF THE INVENTION

At present, polycarbonate is one of the thermoplastics that have been widely used in many industries such as car industry, appliance industry, and electronic industry. This is because polycarbonate has many excellent properties such as high heat resistance, transparency, non-flammable, high dimension stability, high gloss and high glass transition temperature. However, some of polycarbonate properties results in a limitation of some applications such as solution and chemical resistance, weatherability, and high melt viscosity. This causes the injection process to be operated at a high temperature in order to reduce the viscosity of polycarbonate during the injection process. Therefore, there have been several attempts to overcome said problems by blending polycarbonate with other polymers as polymer blends or polymer alloys.

It has been known that the blending of acrylonitrile-butadiene-styrene polymer (ABS) with polycarbonate can overcome above problem and improve the impact strength property of polycarbonate. However, polycarbonate/acrylonitrile-butadiene-styrene (PC/ABS) generally reduces the weatherability due to the degradation of double bond in butadiene when it is used for an outdoor application and exposes to the ultraviolet light. This leads to the reduction of its impact strength and a change of material color. Therefore, there have been several attempts to solve said problem while maintaining other good properties of polycarbonate.

It has been disclosed that the use of acrylonitrile-styrene-acrylate polymer (ASA) instead of acrylonitrile-butadiene-styrene polymer in polycarbonate blend could improve polycarbonate properties. Moreover, this would also improve its weatherability because acrylonitrile-styrene-acrylate polymer is more stable to ultraviolet light than acrylonitrile-butadiene-styrene polymer. However, the limitation of acrylonitrile-styrene-acrylate polymer is its low refractive index comparing to polycarbonate. This results in the incompatibility when it is blended with polycarbonate.

U.S. Pat. No. 3,891,719 disclosed the thermoplastic composition comprising 20 to 50 wt % of polycarbonate and 80 to 20 wt % of acrylonitrile-styrene-acrylate polymer. However, it was found that the impact strength of obtained composition was low, which was about 300 J/m. This would limit its use in some applications that needs high strength property.

U.S. Pat. No. 4,839,426 disclosed the thermoplastic composition comprising 25 to 87 wt % of polycarbonate and 10 to 75 wt % of acrylonitrile-styrene-acrylate polymer, in which said composition required an addition of polysulfone carbonate copolymer for the compatibility of polycarbonate and acrylonitrile-styrene-acrylate polymer.

U.S. Pat. No. 7,563,846 disclosed the thermoplastic composition comprising 50 to 98 wt % of polycarbonate and 1 to 30 wt % of acrylonitrile-styrene-acrylate polymer, and a low gloss additive. The resulted composition had high impact strength because of the relatively low proportion of acrylonitrile-styrene-acrylate polymer. However, the low gloss of the composition according to said patent can limit its use in applications requiring high gloss property, such as automotive parts, housing for electronic appliances, and exterior car decorative articles.

Ye Han et al., (Polym. Bull., 2009, 62, 855-866) disclosed the thermoplastic composition of polycarbonate, acrylonitrile-styrene-acrylate polymer, and styrene-acrylonitrile copolymer (SAN). The study revealed the effect of the amount of acrylonitrile-styrene-acrylate polymer on the impact strength of the resulted polymer. It was found that the impact strength increased when increasing the amount of acrylonitrile-styrene-acrylate polymer. The 20 wt % of acrylonitrile-styrene-acrylate polymer yielded the highest impact strength of 600 J/m. However, it was found that when the amount of acrylonitrile-styrene-acrylate polymer is higher than 20 wt %, some properties, particularly the impact strength, reduced dramatically.

WO0236688 disclosed the thermoplastic composition with improved impact strength. Said composition comprised 5 to 95 wt % of polycarbonate and 5 to 70 wt % of acrylonitrile-styrene-acrylate polymer, and an acrylic copolymer having high molecular weight in a range of 400,000 to 1,500,000 at the proportion of 2.5 to 5 wt %. It was found that said high molecular weight acrylic copolymer could improve the impact strength of the thermoplastic composition.

U.S. Pat. No. 6,476,126 disclosed the thermoplastic composition comprising 20 to 40 wt % of acrylonitrile-styrene-acrylate polymer, 10 to 30 wt % of styrene-acrylonitrile copolymer, and 30 to 70 wt % of polycarbonate. Said patent revealed that the acrylonitrile-styrene-acrylate polymer containing a core-shell structure with polystyrene as a core and acrylate as a shell, and grafted with polymer, could improve gloss and haze properties.

From the reasons mentioned above, this invention aims to develop the thermoplastic composition possessing improved mechanical properties, high gloss and high weatherability, in order to broaden applications of this composition, especially outdoor application.

### SUMMARY OF THE INVENTION

The present invention relates to a thermoplastic composition with improved mechanical properties, wherein said thermoplastic composition comprising 60 to 80 parts by weight of aromatic polycarbonate and 20 to 40 parts by weight of acrylonitrile-styrene-acrylate polymer, characterized in that said aromatic polycarbonate has linear structure and its molecular weight is in a range of 20,000 to 35,000 g/mol; and said acrylonitrile-styrene-acrylate polymer comprising 60 wt % or more of rubber grafted with styrene and acrylonitrile polymer and 40 wt % or less of styrene and acrylonitrile polymer.

### BRIEF DESCRIPTION OF DRAWINGS

FIG. 1 shows the comparisons of mechanical and thermal properties between the comparative sample A and the sample according to the invention 1a, which is shown as comparative percentage.

FIG. 2 shows the comparisons of mechanical and thermal properties of the comparative sample A and the sample according to the invention 2a, which is shown as comparative percentage.

FIG. 3 shows the comparisons of mechanical and thermal properties between the comparative sample B and the sample according to the invention 1b, which is shown as comparative percentage.

FIG. 4 shows the comparisons of mechanical and thermal properties between the comparative sample B and the sample according to the invention 2b, which is shown as comparative percentage.

FIG. 5 shows the comparisons of mechanical and thermal properties between the comparative sample C and the sample according to the invention 1c, which is shown as comparative percentage.

FIG. 6 shows the comparisons of mechanical and thermal properties between the comparative sample C and the sample according to the invention 2c, which is shown as comparative percentage.

FIG. 7 shows the weatherability property of the samples according to the invention 1a, 2a, 1b, 2b, 1c, and 2c.

FIG. 8 shows the gloss property of samples according to the invention 1a, 2b, and 1c.

### DETAILED DESCRIPTION OF THE INVENTION

This invention relates to a thermoplastic composition with improved mechanical properties which will be described by the following description.

Any characteristic mentioned herein means to include the application of said characteristic with other characteristics, unless stated otherwise.

### Definitions

Technical terms or scientific terms used herein have definitions as understood by those having an ordinary skilled in the art, unless stated otherwise.

Any tools, equipment, methods, or chemicals mentioned here mean tools, equipment, methods, or chemicals commonly operated or used by those skilled in the art, unless explicated stated otherwise that they are tools, equipment, methods, or chemicals specific used in this invention.

Use of singular noun or singular pronoun with “comprising” in the claims or the specification refers to “one” and also “one or more”, “at least one”, and “one or more than one”.

Throughout this application, the term “about” is used to indicate that any value presented or showed herein may potentially vary or deviate. Such variation or deviation may result from errors of equipment, method, or from individual operator implementing equipment or method.

The “phr” represents the ratio of an additive that is added to the thermoplastic composition per one hundred parts of the thermoplastic composition. Unless stated otherwise, phr is calculated by weight.

The “mechanical properties” refers to the property of composition, article, thermoplastic, or polymer that is changed when there is an action of external force such as tension, compression, shear, or cyclic stress. Herein, mechanical properties include but not limited to stress, strain, ductility, toughness, impact strength, tensile modulus, tensile strength, flexural modulus, flexural strength, or weatherability.

Hereafter, the invention description is shown without any purpose to limit any scope of the invention.

This invention relates to a thermoplastic composition with improved mechanical properties, wherein said aromatic polycarbonate comprising 60 to 80 parts by weight of aromatic polycarbonate and 20 to 40 parts by weight of acrylonitrile-styrene-acrylate polymer, characterized in that:

said aromatic polycarbonate has linear structure and its molecular weight is in a range of 20,000 to 35,000 g/mol; and said acrylonitrile-styrene-acrylate polymer comprising 60 wt % or more of rubber grafted with styrene and acrylonitrile polymer and 40 wt % or less of styrene and acrylonitrile polymer.

In one embodiment, the aromatic polycarbonate has the following structure:

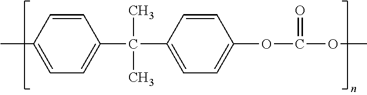

wherein n is an integer number of from 75 to 140.

Preferably, the aromatic polycarbonate has a molecular weight in a range of 22,000 to 27,000 g/mol.

In one embodiment of the invention, the aromatic polycarbonate has a melt flow index in a range of 10 to 23 g/10 min.

In one embodiment, the aromatic polycarbonate may be prepared from melt polymerization of dihydroxy compound and diaryl carbonate ester in the presence of a transesterification catalyst. Preferably, the aromatic polycarbonate according to the invention is prepared from non-phosgene process.

The dihydroxy compound may be bisphenol, which can be selected from but not limited to, (4-hydroxyphenyl)methane, 1,1-bis(4-hydroxyphenyl)methane, 2,2-bis(4-hydroxyphenyl)methane, or be dihydric phenol ether, which can be selected from, but not limited to, bis(4-hydroxyphenyl) ether, bis(3,5-dichloro-4-hydroxyphenyl) ether, or dihydroxyaryl sulfone, which can be selected from, but not limited to, bis(4-hydroxyphenyl) sulfone, bis(3,5-dimethyl-4-hydroxyphenyl) sulfone, or be dihydroxybenzene, which can be selected from, but not limited to, 1,3-dihydroxybenzene, 1,4 dihydroxy benzene, or halo- and alkyl-substituted dihydroxybenzene. Preferably, the dihydroxy compound is 2,2-bis(4-hydroxyphenyl)methane, or dihydric phenol ether.

The acrylonitrile-styrene-acrylate polymer is a styrenic copolymer comprising styrene-acrylonitrile matrix having an acrylate or acrylate copolymer dispersed in the matrix. The acrylate (co)polymer particle may be grafted with styrene-acrylonitrile chain in order to make a good dispersion of acrylate (co)polymer particle in the styrene-acrylonitrile matrix.

In one embodiment, the acrylonitrile-styrene-acrylate polymer is prepared from emulsion polymerization and may be improved to have desirable properties by re-blending with styrene-acrylonitrile polymer.

Preferably, the acrylonitrile-styrene-acrylate polymer comprises about 60 to 70 wt % of rubber grafted with styrene and acrylonitrile polymer and about 30 to 40 wt % of styrene and acrylonitrile polymer.

In one embodiment, the acrylonitrile-styrene-acrylate polymer may have a molecular weight in a range of about 100,000 to 170,000 g/mol, preferably in a range of about 120,000 to 150,000 g/mol.

In one embodiment, the rubber grafted with styrene and acrylonitrile polymer is prepared from emulsion polymerization.

In one embodiment, the rubber is an acrylate rubber prepared from at least monomer selected from methyl acrylate, ethyl acrylate, butyl acrylate, propyl acrylate, 2-ethylhexyl acrylate, hexyl acrylate, 2-methylpropyl acrylate, heptyl acrylate, octyl acrylate, decyl acrylate, phenyl acrylate, benzyl acrylate, hydroxyethyl acrylate, and 2-hydroxypropyl acrylate, preferably methyl acrylate, ethyl acrylate, butyl acrylate, propyl acrylate, 2-ethylhexyl acrylate, or hexyl acrylate.

In one embodiment, the styrene and acrylonitrile polymer comprises a styrene selected from styrene, α-methylstyrene, p-methylstyrene, 3-methylstyrene; or a mixture thereof, preferably styrene, α-methylstyrene, or a mixture thereof.

In one embodiment, the thermoplastic composition may further comprise an additive selected from a light stabilizer, a heat stabilizer, an antioxidant, or a mixture thereof.

In one embodiment; the antioxidant may be selected from organophosphate or hindered phenol, preferably hindered phenol.

Most preferably, the antioxidant is the hindered phenol selected from distearylthiopropionate, dilaurylthiopropionate, ditridecylthiodipropionate, octadecyl-3-(3,5-di-tert-butyl-4-hydroxyphenyl)propionate, or pentaerythrityl-tetrakis[3-(3,5-di-tert-butyl-4-hydroxyphenyl)propionate.

In one embodiment, the antioxidant may be used in a range of 0.3 to 0.7 phr.

In one embodiment, the thermoplastic composition has an impact strength more than 550 J/m, preferably in a range of 550 to 750 J/m.

In another aspect of the invention, the invention relates to an article prepared from the thermoplastic composition according to the invention, wherein the processing method of said article can be the general processing method for the thermoplastic composition that may be selected from, but not limited to, extrusion, compression forming, injection molding, or cast molding.

The following examples are presented to further illustrate the present invention without any purpose to limit the scope of the invention.

Chemical

The aromatic polycarbonate PC110 sold by Chi Mei Corporation with molecular weight about 25,000 g/mol was used for the preparation of sample according to the invention.

The acrylonitrile-styrene-acrylate polymer KIBILAC 997 sold by Chi Mei Corporation with molecular weight about 145,000 g/mol, comprising about 60 to 70 wt % of acrylate rubber grafted with styrene-acrylonitrile polymer and about 30 to 40 wt % of styrene-acrylonitrile polymer, were used for the preparation of sample according to the invention.

The acrylonitrile-styrene-acrylate polymer KIBILAC 978 sold by Chi. Mei Corporation with molecular weight about 125,000 g/mol, comprising about 60 to 70 wt % of acrylate rubber grafted with styrene-acrylonitrile polymer and about 30 to 40 wt % of styrene-acrylonitrile polymer, were used for the preparation of sample according to the invention.

The antioxidant AUK STAB A050 sold by Adeka Fine Chemical was used for the preparation of the sample according to the invention.

Carbon black sold by DIC Corporation was used for the preparation of sample according to the invention.

WR7350 sold by Samsung SDI Chemical having a density of 1.16 g/cm³ and a weight ratio of polycarbonate to acrylonitrile-styrene-acrylate polymer about 80:20 was used as comparative sample A.

Geloy XTPM307 sold by Sabic having a density of 1.15 g/cm³ and a weight ratio of polycarbonate to acrylonitrile-styrene-acrylate polymer about 70:30 was used as comparative sample B.

Lupoy EU5008 sold by LG Chem having a density of 1.14 g/cm³ and a weight ratio of polycarbonate to acrylonitrile-styrene-acrylate polymer about 60:40 was used as comparative ample C.

Preparation of Sample According to the Invention

The present invention illustrates the thermoplastic composition with improved mechanical properties which can be prepared by the following method.

Before being used, the aromatic polycarbonate was dried in the vacuum oven for 4 hours at the temperature about 110° C., and the acrylonitrile-styrene-acrylate polymer was dried in the vacuum oven for about 4 hours at the temperature about 90° C. After that, the thermoplastic compositions comprising various compositions and proportions as shown in Table 1 were blended by a melt mixing method using a twin-screw extruder (Thermo Haake RheoMex PTW24-MC) with screw diameter of about 24 mm and the temperature was controlled to be about 210 to 240° C. in all zones. Then, the obtained mixture was cooled down in water and pelletized by a pelletizer. The pelletized thermoplastic composition was dried in the vacuum oven for 4 hours at the temperature of about 90° C. Then, to prepare a sample for testing its properties, the pelletized sample was molded by an injection molding machine (Toshiba EC100II2A) at the temperature of about 240 to 250° C.

The following is the property testing of samples prepared from the thermoplastic compositions according to the invention, wherein the methods equipment used in the test are commonly used and are not intended to limit the scope of the invention.

Density

Density was determined by water displacement method according to ASTM D 792-00. The dimension of testing sample was 20×35×3 mm. The testing was performed at room temperature.

Melt Flow Index

Melt flow index was determined by a melt flow indexer (Model 10 Davenport Lloyd instruments) according to ASTM D 1238 at the temperature of about 260° C. under 5 kg weight,

Impact Strength

Impact strength was determined by Notched Izod Impact technique according to ASTM D256 by Instron instrument, CEAST model 9310, The testing sample had a length of about 63 mm, a width of about 12.7 mm, and a thickness of about 3 mm. A 2 mm depth notch was made on a center of each sample.

Tensile Modulus and Tensile Strength

Tensile modulus and tensile strength were determined by Instron Instrument model 5567 by using 3 mm long dog bone molded sample according to ASTM D638, The tensile test rate was about 50 ram/min and the gauge length was about 2.5 mm.

Flexural Modulus and Flexural Strength

Flexural modulus and flexural strength were determined by Instron Instrument model 5567 using 3.2 mm thick bar molded sample according to ASTM D790 with a compression rate of about 1.3 mm/min.

Heat Distortion Temperature and VICAT Softening Temperature

Heat distortion temperature and VICAT softening temperature were determined by CEAST HDT according to ASTM D648 and ASTM D1525 respectively, using 3.2 mm thick bar molded sample. The HDT was tested under a stress of about 1.8 MPa and VICAT was tested under a load of about 5 kg.

Weatherability

Weatherability was determined by an accelerated weather simulation according to ASTM G154 using QUV Weatherometer Model Q-Spray. A testing sample was molded in the same shape and size as for the impact strength testing. Then, the sample was subjected to the QUV with UVB light intensity about 0.48 watts/m² for about 8 hours alternately with water sprayed in a dark condition for 4 hours until 1 week per 1 testing cycle. Then, the UVB light exposed sample was tested for determining the impact strength in each week. The percent relative impact strength was calculated from the ratio of impact strength at each time to the initial impact strength without UVB exposure.

Gloss

Gloss was determined by a gloss mater. A testing sample was placed horizontally in which testing area faced to the gloss meter with 60. Then, the position was changed into 5 testing areas which were all 4 corners and the center. The gloss result was the average value of 5 areas. The results are shown in FIG. 8.

Table 1 shows compositions of the thermoplastic composition sample

| | Compositions | | | |
|---|---|---|---|---|
| | Aromatic | Acrylonitrile-styrene- | Anti- | Carbon |
| | polycarbonate | acrylate polymer | oxidant | black |
| Samples | (wt %) | (wt %) | (phr) | (phr) |
| Comparative | WR7350 with a weight ratio of aromatic polycarbonate | | | |
| sample A | to acrylonitrile-styrene-acrylate polymer about 80:20 | | | |
| Comparative | Geloy XTPM307 with a weight ratio of aromatic | | | |
| sample B | polycarbonate to acrylonitrile-styrene- | | | |
| | acrylate polymer about 70:30 | | | |
| Comparative | Lupoy EU5008 with a weight ratio of aromatic | | | |
| sample C | polycarbonate to acrylonitrile-styrene- | | | |
| | acrylate polymer about 60:40 | | | |
| Sample 1a | PC110 (80%) | KIBILAC 978 (20%) | 0.5 | 1 |
| Sample 2a | PC110 (80%) | KIBILAC 997 (20%) | 0.5 | 1 |
| Sample 1b | PC110 (70%) | KIBILAC 978 (30%) | 0.5 | 1 |
| Sample 2b | PC110 (70%) | KIBILAC 997 (30%) | 0.5 | 1 |
| Sample 1c | PC110 (60%) | KIBILAC 978 (40%) | 0.5 | 1 |
| Sample 2c | PC110 (60%) | KIBILAC 997 (40%) | 0.5 | 1 |

Table 2 shows properties of the thermoplastic composition sample

| | Properties | | |
|---|---|---|---|
| | Density | Melt flow index | Impact Strength |
| Samples | (g/cm³) | (g/10 min) | (J/m) |
| Comparative sample A | 1.16 | 30 | 560 |
| Comparative sample B | 1.15 | 16 | 600 |
| Comparative sample C | 1.14 | 24 | 580 |
| Sample 1a | 1.16 | 25 | 647 |
| Sample 2a | 1.16 | 19 | 745 |
| Sample 1b | 1.15 | 27 | 572 |
| Sample 2b | 1.15 | 23 | 684 |
| Sample 1c | 1.14 | 31 | 538 |
| Sample 2c | 1.14 | 29 | 615 |

Table 2 shows the impact strength, melt flow index, and density properties of comparative samples and samples according to the invention. From the table, when comparing the comparative sample A to the samples 1a, 2a; the comparative sample B to the samples 1b, 2b; and the comparative sample C to the samples 1c, 2c, which have the same proportions of aromatic polycarbonate and acrylonitrile-styrene-acrylate polymer compositions, it is found that the samples according to the invention gave higher impact strength than the comparative samples. Particularly, the sample according to the invention 2a which comprising 80 parts by weight of aromatic polycarbonate and 20 parts by weight of acrylonitrile-styrene-acrylate polymer results in the highest impact strength.

Moreover, when comparing the samples according to the invention 1a and 2a, the samples 1b and 2b, and the samples is and 2c, it can be seen that the samples 2a, 2b, and 2c, which comprising higher molecular weight acrylonitrile-styrene-acrylate polymer yields higher impact strength than the samples 1a, 1b, and 1c respectively.

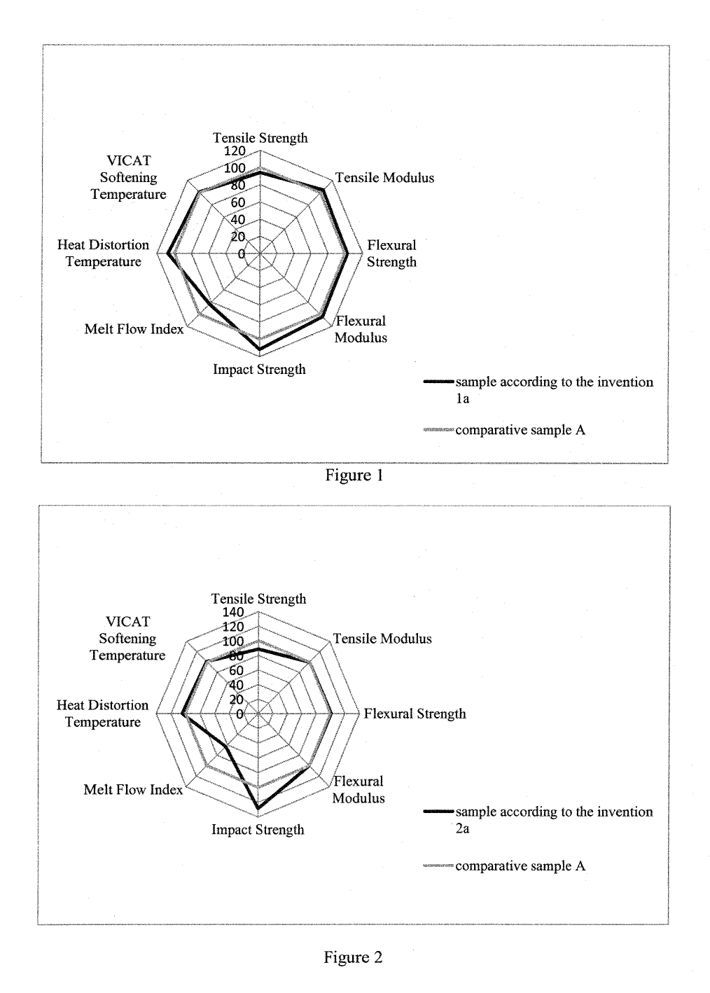

FIGS. 1 and 2 represent the comparisons of mechanical and thermal properties between the comparative sample A to the samples according to the invention 1a and 2a respectively. It can be observed that the samples according to the invention provide better mechanical and thermal properties that can be seen from higher tensile strength, tensile modulus, flexural strength, flexural modulus, impact strength, heat distortion temperature; and VICAT softening temperature.

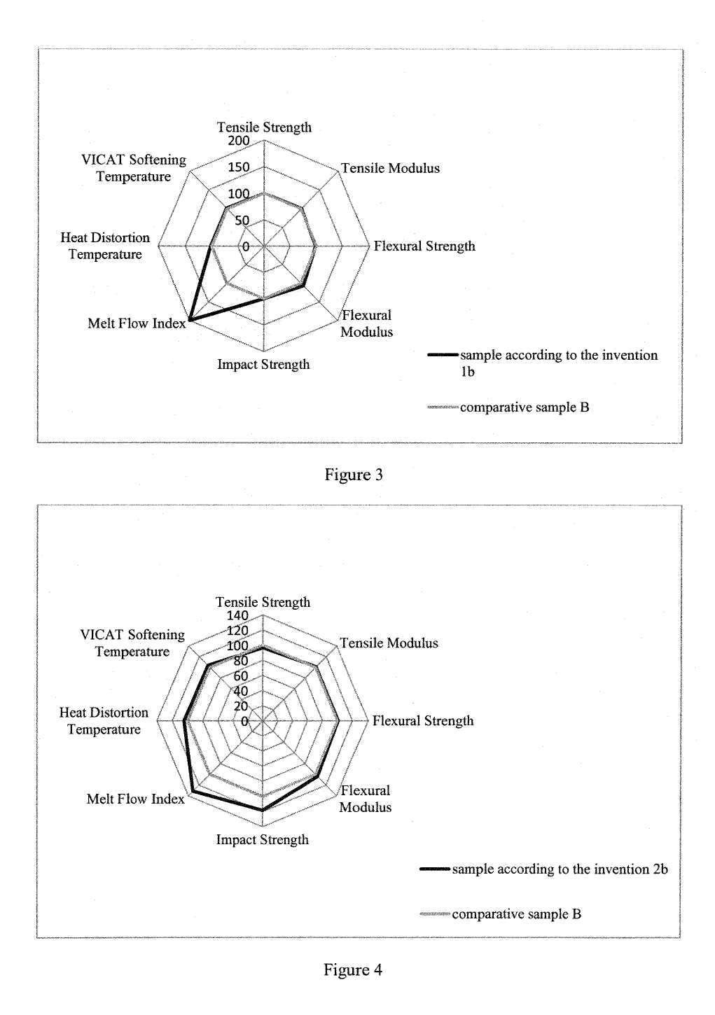

FIGS. 3 and 4 represent the comparisons of mechanical and thermal properties between the comparative sample B to the samples according to the invention 1b and 2b respectively. It can be apparently observed that the samples according to the invention 1b and 2b provide greatly higher melt flow index, while the mechanical properties remain high.

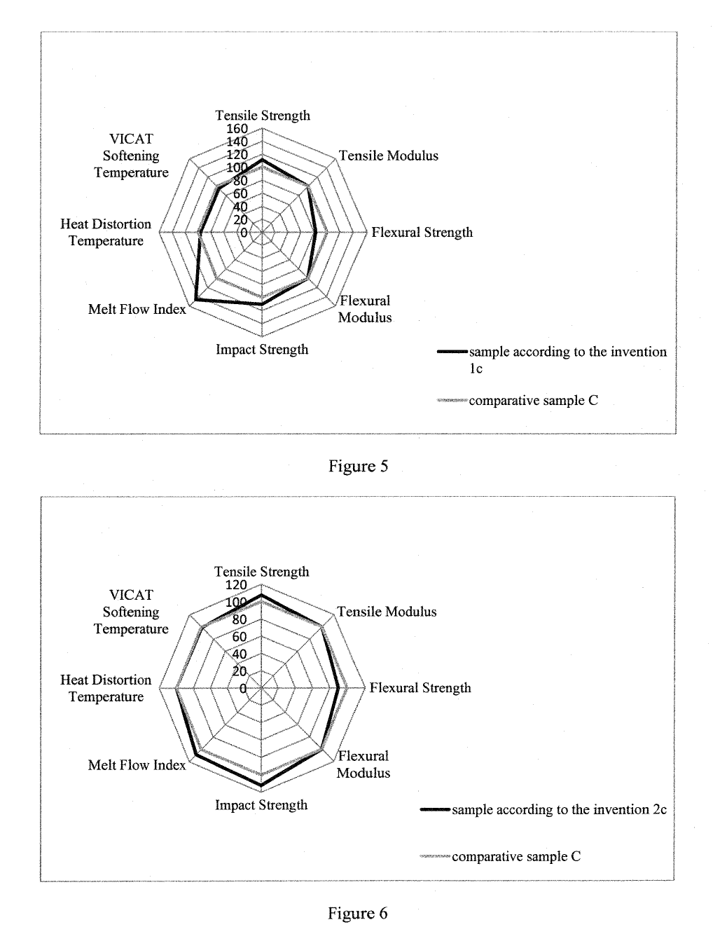

FIGS. 5 and 6 represent the comparisons of mechanical and thermal properties between the comparative sample C to the samples according to the invention 1c and 2c respectively. It can be seen that the samples according to the invention 1c and 2c provide higher melt flow index and mechanical properties in terms of impact strength and tensile strength.

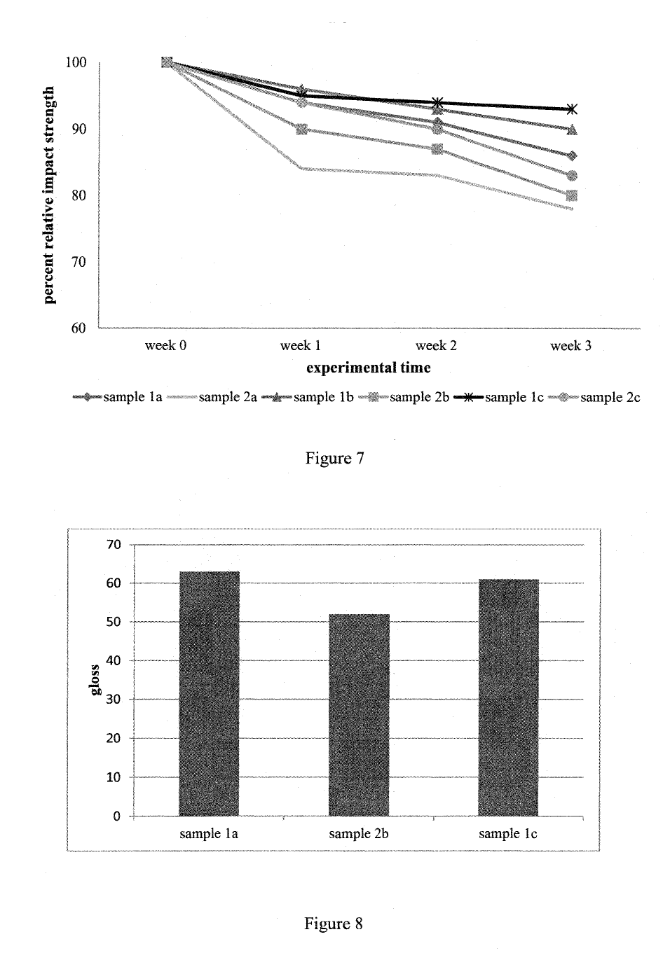

FIG. 7 represents the weatherability during 1 to 3 weeks. It can be found that the sample according to the invention 1c which comprising aromatic polycarbonate and acrylonitrile-styrene-acrylate polymer in the weight ratio of 60:40 results in the highest weatherability. This can be illustrated from the lowest reduction rate of the percent relative impact strength.

Regarding results above, it can be summarized that the thermoplastic composition according to the invention provides good mechanical properties with high gloss and weatherability as indicated in the objective of this invention.

### BEST MODE OF THE INVENTION

Best mode of the invention is as provided in the description of the invention.

1. A thermoplastic composition with improved mechanical properties comprising 60 to 80 parts by weight of aromatic polycarbonate and 20 to 40 parts by weight of acrylonitrile-styrene-acrylate polymer, characterized in that:
said aromatic polycarbonate has linear structure and its molecular weight is in a range of 20,000 to 35,000 g/mol; and
said acrylonitrile-styrene-acrylate polymer comprising 60 wt % or more of rubber grafted with styrene and acrylonitrile polymer and 40 wt % or less of styrene and acrylonitrile polymer.

2. The thermoplastic composition according to claim 1, wherein the aromatic polycarbonate has the following structure: 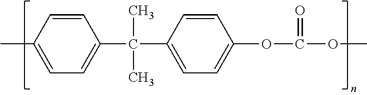
wherein n is an integer number of from 75 to 140.

3. The thermoplastic composition according to claim 1, wherein the aromatic polycarbonate has a molecular weight in a range of 22,000 to 27,000 g/mol.

4. The thermoplastic composition according to claim 1, wherein the aromatic polycarbonate has a melt flow index in a range of 10 to 23 g/10 min.

5. The thermoplastic composition according to claim 1, wherein the aromatic polycarbonate is prepared from melt polymerization with a non-phosgene process.

6. The thermoplastic composition according to claim 1, wherein the acrylonitrile-styrene-acrylate polymer comprising 60 to 70 wt % of rubber grafted with styrene and acrylonitrile polymer and 30 to 40 wt % of styrene and acrylonitrile polymer.

7. The thermoplastic composition according to claim 1, wherein the acrylonitrile-styrene-acrylate polymer has a molecular weight in a range of 120,000 to 150,000 g/mol.

8. The thermoplastic composition according to claim 1, wherein the rubber grafted with styrene and acrylonitrile polymer is prepared by emulsion polymerization.

9. The thermoplastic composition according to claim 1, wherein the rubber is an acrylate rubber prepared from at least one monomer selected from methyl acrylate, ethyl acrylate, butyl acrylate, propyl acrylate, 2-ethylhexyl acrylate, or hexyl acrylate.

10. The thermoplastic composition according to claim 1, wherein the styrene and acrylonitrile polymer comprising a styrene selected from styrene, α-methylstyrene, p-methylstyrene, 3-methylstyrene, or a mixture thereof.

11. The thermoplastic composition according to claim 10, wherein the styrene and acrylonitrile polymer comprising the styrene selected from styrene, α-methylstyrene, or a mixture thereof.

12. The thermoplastic composition according to claim 1, wherein the thermoplastic composition further comprises an additive selected from a light stabilizer, a heat stabilizer, an antioxidant, or a mixture thereof.

13. The thermoplastic composition according to claim 12, wherein the antioxidant is hindered phenol.

14. The thermoplastic composition according to claim 12, wherein the antioxidant is used in a range of 0.3 to 0.7 phr.

15. The thermoplastic composition according to claim 1, wherein said thermoplastic composition has an impact strength in a range of 550 to 750 J/m.

16. Article prepared from the thermoplastic composition according to claim 1.

17. The thermoplastic composition according to claim 2, wherein the aromatic polycarbonate has a molecular weight in a range of 22,000 to 27,000 g/mol.

18. The thermoplastic composition according to claim 6, wherein the acrylonitrile-styrene-acrylate polymer has a molecular weight in a range of 120,000 to 150,000 g/mol.

19. The thermoplastic composition according to claim 6, wherein the rubber grafted with styrene and acrylonitrile polymer is prepared by emulsion polymerization.

20. The thermoplastic composition according to claim 13, wherein the antioxidant is used in a range of 0.3 to 0.7 phr.
